(19) United States
(12) Patent Application Publication
(10) Pub. No.: US 2015/0137510 A1
(43) Pub. Date: May 21, 2015

(54) DEVICE FOR CONNECTING A TAP AND/OR EXTERNAL WATER SOURCE AND WATER SUPPLY HOSE

(71) Applicant: Dongbu Daewoo Electronics Corporation, Seoul (KR)

(72) Inventor: Seong Bo HONG, Seoul (KR)

(73) Assignee: Dongbu Daewoo Electronics Corporation, Seoul (KR)

(21) Appl. No.: 14/133,378

(22) Filed: Dec. 18, 2013

(30) Foreign Application Priority Data
Nov. 21, 2013 (KR) 10-2013-0142197

(51) Int. Cl. F16L 33/24; E03B 9/00

(52) U.S. Cl. CPC F16L 33/24; E03B 9/00
USPC 285/245; 29/890.14

(57) ABSTRACT

A device for connecting a tap and/or external water source and a water supply hose including an elastic sealing unit configured to receive or contact an end of the tap; a tightening unit including a screw groove on an inner surface thereof, having an inner diameter that decreases from an opening to a bottom of the screw groove; and a connection unit including a coupling portion having the elastic sealing unit therein, a screw thread on an outer peripheral surface thereof configured to mate with or receive the screw groove of the tightening unit, and a hose connection portion configured to connect an end of the hose, wherein an inner diameter of the elastic sealing unit is smaller than an outer diameter of the end of the tap and/or external water source, and an inner diameter of the elastic sealing unit decreases from one end to another end.

### CROSS-REFERENCE TO RELATED APPLICATIONS

This application is based on and claims priority from Korean Patent Application No. 10-2013-0142197, filed on Nov. 21, 2013, the disclosure of which is incorporated herein in its entirety by reference.

### TECHNICAL FIELD

The present disclosure relates to a device for connecting a tap and/or external water source and a water supply hose, and more particularly, to a device for connecting a tap and/or external water source and a water supply hose that may be easily mounted on the tap without additional tools and may be effectively attached to the tap to prevent water leakage.

### BACKGROUND

In general, in a washing machine, water is supplied to the inside of a body through a water supply port formed at an upper portion of the body to perform a washing operation. The water supply port is connected to a tap through a water supply hose. When the water supply hose is directly connected to the tap, a phenomenon occurs in which the water supply hose may separate from the tap due to the pressure of water from the tap. To minimize such a phenomenon, the tap and the water supply hose are joined to each other by an additional connection device.

A conventional connection device 10 for connecting the tap and the water supply hose includes a fixation port 11 having a plurality of screw holes 14 in an upper portion that is joined or fixed to an outer peripheral surface of a tap 1 by a screw 13. A thread 15 is on a lower outer peripheral surface of the connection device 10, and a connection port 12 having a screw groove 16 on an upper inner peripheral surface into which the thread 15 of the fixation port is screwed. A fitting portion 17 has an end of the water supply hose 2 coupled to a lower outer peripheral surface thereof, as illustrated in FIG. 1. A rubber seal or gasket 18 that contacts the end of the tap may be placed in the fixation port 11.

However, the conventional connection device lOrequires additional tools, such as a screwdriver, or the like to tighten the plurality of screws 13, in order to couple the fixation port 11 to the tap. If any of the plurality of screws 13 becomes loose, the rubber seal or gasket 18 placed in the fixation port and the end of the tap 1 may become loose, and as a result, water may leak.

A conventional tap connection may be disclosed in Korean Patent Application Laid-Open No. 2000-0034047.

### SUMMARY

The present disclosure has been made in an effort to provide a device for connecting a tap and/or external water source (such as a faucet, pipe, hose, tube, etc.) and a water supply hose that may be easily mounted on the tap and/or external water source without requiring additional tools and effectively attaches to the tap and/or external water source, preventing water leakage.

Exemplary embodiments of the present disclosure provide a device for connecting a tap and/or external water source and a water supply hose, including an elastic sealing unit configured to receive or contact an end of the tap and/or external water source; a tightening unit including a screw groove (or thread) on an inner surface thereof, and having an inner diameter that decreases from an opening to a bottom of the screw groove (e.g., the inner surface of the tightening unit is tapered); and a connection unit including a coupling portion having the elastic sealing unit therein, a screw thread on an outer peripheral surface thereof configured to mate with or receive the screw groove of the tightening unit, and a hose connection portion configured to connect an end of a water supply hose, wherein an inner diameter of the elastic sealing unit is smaller than an outer diameter of the end of the tap and/or external water source, and an inner diameter of the elastic sealing unit decreases from one end to another end (e.g., the elastic sealing unit has a tapered inner surface).

The device may further comprise a fixation unit on the top of the elastic sealing unit and fixed to an outer surface of an end of the tap or external water source.

The fixation unit includes a plurality of fixation portions at intervals along a circumference of the fixation unit, a plurality of connection portions connecting the fixation portions to each other, configured to be elastically connected (e.g., allow flexibility), and a plurality of metal pins on the fixation portions and contacting the outer surface of the end of the tap and/or external water source.

According to exemplary embodiments of the present disclosure, a device for connecting a tap and/or external water source and a hose (e.g., a water supply hose) may be conveniently mounted on the tap and/or external water source without use of additional tools, and may provide efficient contact and/or connection between the tap and/or external water source and the water supply hose to prevent water leakage.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a semi-cross-sectional view illustrated by disassembling a conventional device for connecting between a tap and a water supply hose.

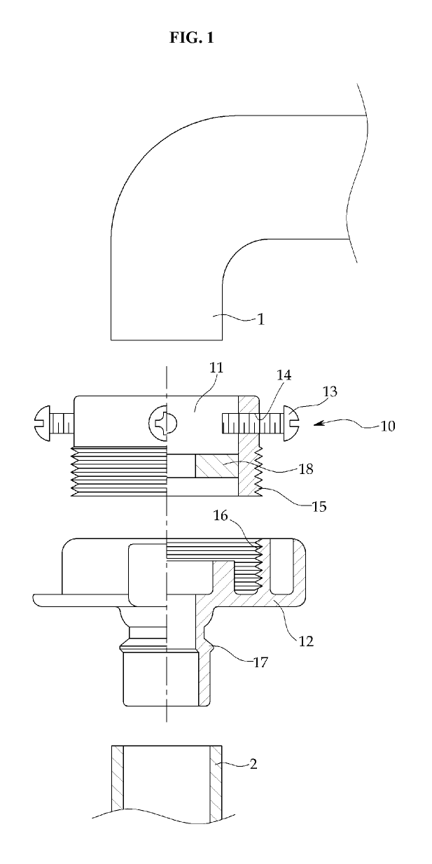

FIG. 2 is a perspective view illustrating an exemplary device for connecting a tap and/or external water source and a water supply hose according to exemplary embodiments of the present disclosure.

FIG. 3 is an exploded perspective view illustrating the exemplary device for connecting a tap and a water supply hose according to embodiments of the present disclosure.

FIG. 4 is an exploded cross-sectional view illustrating the exemplary device for connecting a tap and a water supply hose according to the embodiments of the present disclosure.

FIG. 5 is a cross-sectional view illustrating the exemplary device for connecting a tap and a water supply hose according to the embodiments of the present disclosure.

FIG. 6 is a cross-sectional view illustrating the exemplary device for connecting a tap and a water supply hose according to the embodiments of the present disclosure is coupled to the tap.

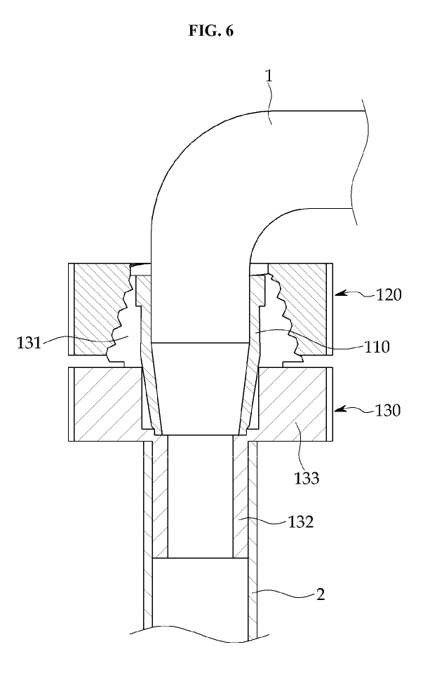

FIG. 7 is an exploded perspective view illustrating an exemplary device for connecting a tap and a water supply hose according to embodiments of the present invention.

FIG. 8 is a cross-sectional view illustrating the exemplary device for connecting a tap and a water supply hose according to embodiments of the present invention.

### DETAILED DESCRIPTION

In the following detailed description, reference is made to the accompanying drawings, which forms a part hereof. The illustrative embodiments described in the detailed description, drawings, and claims are not meant to be limiting. Other embodiments may be utilized, and other changes may be made, without departing from the spirit or scope of the subject matter presented here.

One or more exemplary embodiments of the present disclosure will be described in detail hereinafter with reference to the accompanying drawings, in which other exemplary embodiments of the disclosure can be easily determined by those skilled in the art. As those skilled in the art will realize, the described exemplary embodiments may be modified in various different ways, all without departing from the spirit or scope of the present disclosure, which is not limited to exemplary embodiments described herein. A configuration and an operational effect according to exemplary configurations of the present disclosure will be clearly understood through the detailed description below. Like reference numerals designate like elements throughout the specification and drawings. A detailed explanation of known related functions and constitutions may be omitted when the detailed explanation obscures the subject matter of the present disclosure.

It is noted that the drawings are schematic and are not necessarily dimensionally illustrated. Relative sizes and proportions of parts in the drawings may be exaggerated or reduced in their sizes, and a predetermined size is just exemplary and not limiting.

The exemplary embodiments of the present disclosure illustrate ideal exemplary embodiments of the present disclosure in more detail. As a result, various modifications of the drawings are expected. Accordingly, the exemplary embodiments are not limited to a specific form of the illustrated region, and for example, include a modification of a form by manufacturing.

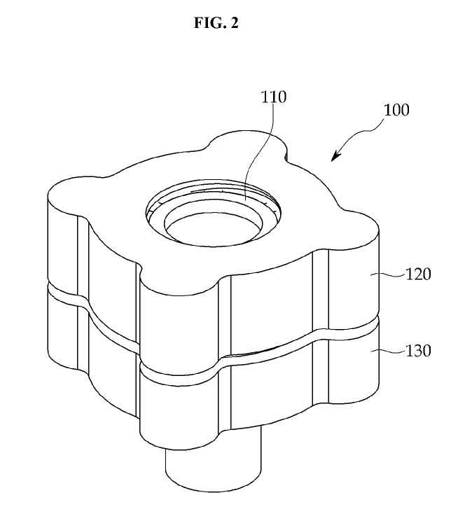

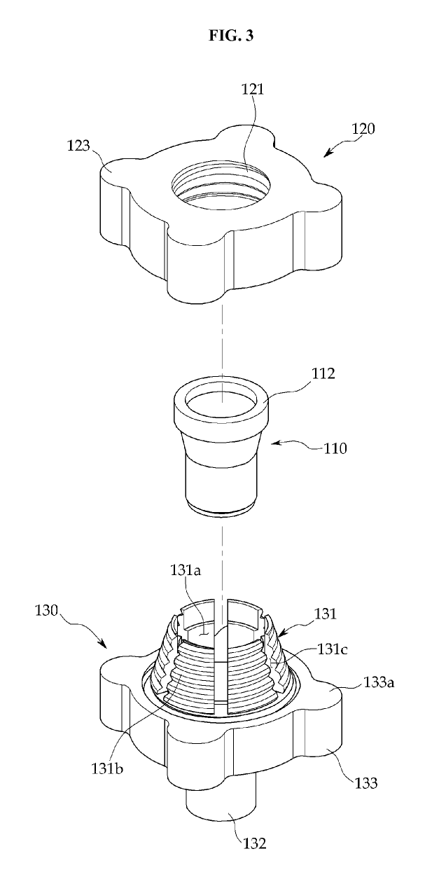

FIGS. 2 and 3 are a perspective view and an exploded perspective view of an exemplary device 100 for connecting a tap and/or external water source and a water supply hose (hereinafter, referred to as a “connection device”), and the connection device 100 includes an elastic sealing unit 110, a tightening unit 120, and a connection unit 130.

In the present disclosure, the elastic sealing unit 110 is configured to attach to an end of a tap 1, and as a result, the connection device 100 of the present disclosure and the end of the tap 1 are sealed to prevent water leakage.

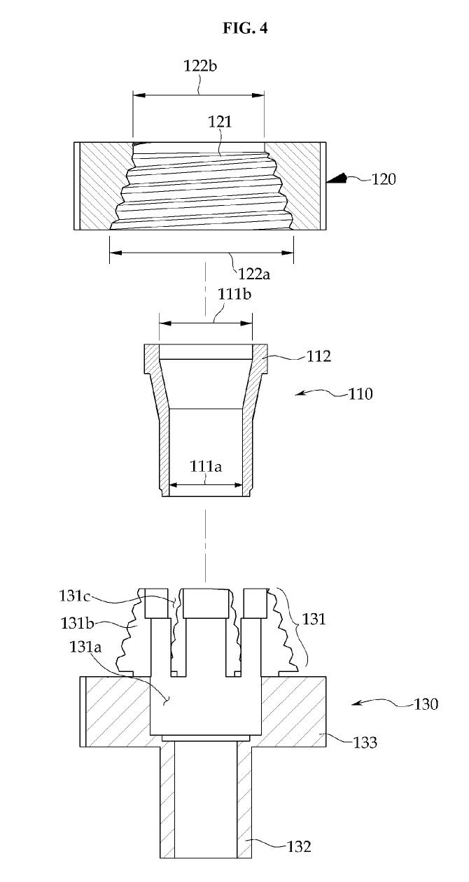

A lower inner diameter 111a (FIG. 4) of the elastic sealing unit 110 is smaller than an outer diameter of the tap and/or external water source end 1. When the end of the tap 1 is inserted into the elastic sealing unit 110, the end of the tap 1 may be pressed and fixed or sealed in the elastic sealing unit, causing expansion of a side wall of the elastic sealing unit 110. As such, since the elastic sealing unit 110 and the end of the tap 1 are pressed and fixed or sealed, the elastic sealing unit 110 may not move or slide downward by the water pressure, thus effectively preventing water leakage.

However, when an upper inner diameter 111b of the elastic sealing unit is equal to the lower inner diameter 111a which is smaller than the outer diameter of the end of the tap, it may be difficult for a user to fit the end of the tap into the elastic sealing unit 110. Accordingly, as illustrated in FIG. 4, the inner diameter of the elastic sealing unit 110 decreases from one end (e.g., the top) to another end (e.g., the bottom). Thus, the inside of the elastic sealing unit 110 may have an inverse truncated cone or conical shape. For example, the inner diameter 111 may gradually decrease or taper from one end (e.g., the top) to a middle (e.g., of the elastic sealing unit 110), or the inner diameter 111 of the elastic sealing unit 110 may gradually decrease or taper from the one end to the other end.

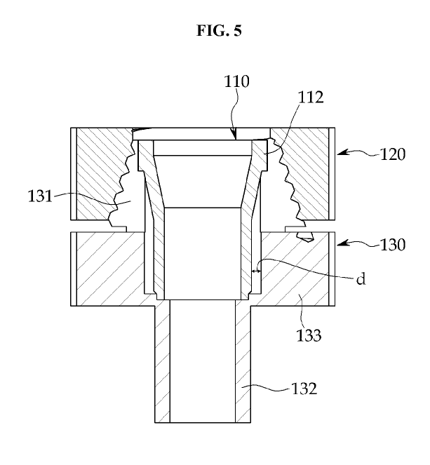

An outer diameter of the elastic sealing unit 110 may also decrease or taper from the one end to the other end. For example, similar to the inner diameter, the outer diameter may gradually decrease or taper from one end (e.g., the top) to a middle (e.g., of the elastic sealing unit 110), or the outer diameter may gradually decrease or taper from the one end to the other end. Accordingly, as illustrated in FIG. 5, the elastic sealing unit 110 is spaced apart from an inner side wall of the connection unit 130 and/or an inner side wall of the coupling portion 131 by a predetermined distance d. As a result, the end of the tap and/or external water source 1 may be easily inserted into the elastic sealing unit 110 and/or closely fit into the elastic sealing unit 110.

The spacing distance d between the outer side of the elastic sealing unit and the inner side wall of the coupling portion is not particularly limited. However, when the spacing distance is too wide, even though the elastic sealing unit expands when the end of the tap is inserted into the elastic sealing unit, a gap remains between the outer side wall of the elastic sealing unit and the inner side wall of the coupling portion. As a result, the seal between the coupling portion and the elastic sealing unit may deteriorate. Accordingly, a spacing distance between the outer side wall of the elastic sealing unit and a side wall of the coupling portion is preferably controlled by determining the outer diameter and expansion rate of the elastic sealing unit.

The elastic sealing unit 110 may include a flange portion 112 that may contact the top of the connection unit 130. The flange portion 112 may contact an uppermost and/or an upper distal end of the connection unit. The flange portion 112 of the elastic sealing unit may contact the upper distal end of an inner peripheral surface of the connection unit 130 (e.g., inside the coupling portion 131) to prevent the elastic sealing unit from moving downward by the water pressure.

The material of the elastic sealing unit 110 may comprise an elastic or flexible material, and the material of the elastic sealing unit 110 is not particularly limited. The material of the elastic sealing unit 110 may include a natural rubber, a synthetic rubber (e.g., a polyurethane rubber, an acrylic or acrylate rubber, a silicon rubber, a latex rubber, a styrene-butadiene rubber, a nitrile rubber), and the like, and is not particularly limited thereto.

In the present disclosure, the tightening unit 120 serves to press and fix the elastic sealing unit 110 and the coupling portion 131 of the connection unit 130 to the end of the tap and/or external water source 1 without additional tools.

The tightening unit 120 includes a screw groove 121 on an inner peripheral surface thereof. However, as illustrated in FIG. 4, an inner diameter 122 of the tightening unit 120 gradually increases from one end (e.g., the top) to another end (e.g., the bottom). For example, the inner surface of tightening unit 120 may have a tapered, widening, truncated cone and/or conical shape, in that an inner diameter 122a of the tightening unit 120 at the surface where the coupling portion 131 is inserted is larger than an inner diameter 122b where the tap is inserted. As a result, the connection device 100 of the present disclosure presses the coupling portion 131 of the connection unit by rotation of the tightening unit 120 to compress the coupling portion 131. Therefore, the coupling portion 131 of the connection unit 130 may tightly press and fix or seal the end of the tap and/or external water source to the elastic sealing unit 110.

The inner diameter 122b of the tightening unit 120 is not particularly limited and is preferably controlled by determining the outer diameter and compression rate of the coupling portion of the connection unit, the outer diameter of the end of the tap, and the like.

The inner diameter 122a of the tightening unit may be equal to or smaller than the outer diameter of the coupling portion of the connection unit, and larger than the inner diameter 122b. If the material of the connection unit 130 is the elastic and the inner diameter 122a of the tightening unit is smaller than the outer diameter of the coupling portion of the connection unit, the tightening unit 120 may further press the coupling portion of the connection unit to the end of the tap and/or external water source by rotation of the tightening unit 120.

An outer peripheral surface of the tightening unit 120 may have a plurality of protrusions 123 thereon, allowing the user to rotate and tighten the tightening unit without slipping. As a result, the connection unit 130 and the elastic sealing unit 110 may effectively seal and attach to the end of the tap and/or external water source 1.

The material of the tightening unit 120 is not particularly limited and may be plastic, metal, and/or the like.

In the present disclosure, the connection unit 130 is a portion that has the elastic sealing unit 110 therein, that is coupled to the tightening unit 120, and is connected to an end of the water supply hose 2. The connection unit 130 may have a pipe shape and a passage that allows water to pass. The connection unit 130 includes a coupling portion 131 that has the elastic sealing unit 110 therein and that is configured to couple to the tightening unit 120. The connection portion 130 also has a hose connection portion 132 that is below the coupling portion and configured to connect with an end of the hose (e.g., a water supply hose that supplies water to another apparatus, such as a washing machine, sprayer, lawn sprinkler, etc.).

The coupling portion 131 includes a mounting portion 131a having the elastic sealing unit 110 therein, and a thread 131b on an outer peripheral surface thereof, to couple with the screw groove 121 of the tightening unit 120. Since the downward movement of the elastic sealing unit 120 is restricted by the coupling portion 131, the elastic sealing unit 120 may effectively prevent water leakage, even though significant water pressure is applied. The coupling portion 131 is coupled with the tightening unit 120, and as a result, the connection device of the present disclosure may conveniently connect the tap and/or external water source and the hose without additional tools.

The outer diameter of the coupling portion 131 gradually increases from one end to the other end similar to the inner diameter 122 of the tightening unit, so that the thread 131b is coupled with the screw groove 122 of the tightening unit. When the coupling portion 131 having such an outer diameter is coupled with the tightening unit 120, the coupling portion 131 may be solidly sealed and attached to the end of the tap together with the elastic sealing unit 110 by rotating the tightening unit 120. As a result, attachment or sealing between the connection unit and the elastic sealing unit or between the elastic sealing unit and the end of the tap and/or external water source may be further improved.

A plurality of cutout grooves 131c may be formed in the coupling portion 131. The grooves 131c may be perpendicular to the mounting portion 131a. As a result, the coupling portion 131 may be more effectively sealed to the elastic sealing unit when the coupling portion 131 is coupled with the tightening unit 120.

A hose connection portion 132 connected to the end of the hose (e.g., a water supply hose 2) is downstream from the coupling portion 131. A suspension groove (not illustrated) or a suspension ring or protrusion (not illustrated) that may fit in the end of the water supply hose 2 may be on the outer peripheral surface of the hose connection portion 132.

Alternatively, the connection unit 130 may include one or more of projection portions 133 that extend outwards, between the coupling portion 131 and the hose connection portion 132. The projection portion 133 may include metal strip and/or beading on the surface to provide better contact. The connection unit 130 includes the projection portion 133, and as a result, the user may apply external force to the connection unit in a direction opposite to a rotating direction of the tightening unit while stably holding the connection unit 130 without slipping. Therefore, the tightening unit may tighten the coupling portion of the connection unit, and as a result, the coupling portion of the connection unit and the elastic sealing unit may be sealed and attached to the tap and/or external water source.

The material of the connection unit is not particularly limited, but when the material of the connection unit 130 is elastic, the connection unit 130 may be preferably sealed and attached to the elastic sealing unit by rotating the tightening unit 120. Examples of the elastic material include a natural rubber, a synthetic rubber (e.g., a polyurethane rubber, an acryl rubber, a silicon rubber, a latex rubber, a styrene-butadiene rubber, a nitrile rubber), and the like, but not limited thereto.

Installation and an operation of the connecting device between the tap and/or external water source and the water supply hose according to the embodiments of the present disclosure will be described.

First, the elastic sealing unit 110 is placed in the coupling portion 131 of the connection unit 130. Thereafter, after the tightening unit 120 is fitted or placed onto the end of the tap, the end of the tap 1 is inserted into the elastic sealing unit 110 (or vise-versa) and assembled with the connection unit 120. The inner diameter of the elastic sealing unit 110 expands outwards (e.g., placing automatic pressure on sides of the mating members, such as the elastic sealing unit 110, the tightening unit 120, and the connection unit 130), and surrounds the end of the tap to seal and be fixed or attached to the end of the tap. Subsequently, the tightening unit 120 is rotated the tightening unit 120 moves downward while being coupled with the coupling portion 131 of the connection unit. The coupling portion 131 of the connection unit is pressed towards the elastic sealing unit 11 by rotating the tightening unit 12, to seal and fix or attach the connection device 100 to the end of the tap 1. Thereafter, when the end of the water supply hose 2 is connected to the hose connection portion 132 of the connection unit, water can be supplied to another apparatus (such as a washing machine) without leaking from the tap through the connection device and/or the water supply hose. As such, the connection device 100 according to the present disclosure is conveniently mounted on a tap without additional tools, to connect the tap and/or external water source and the water supply hose, and prevent water leakage.

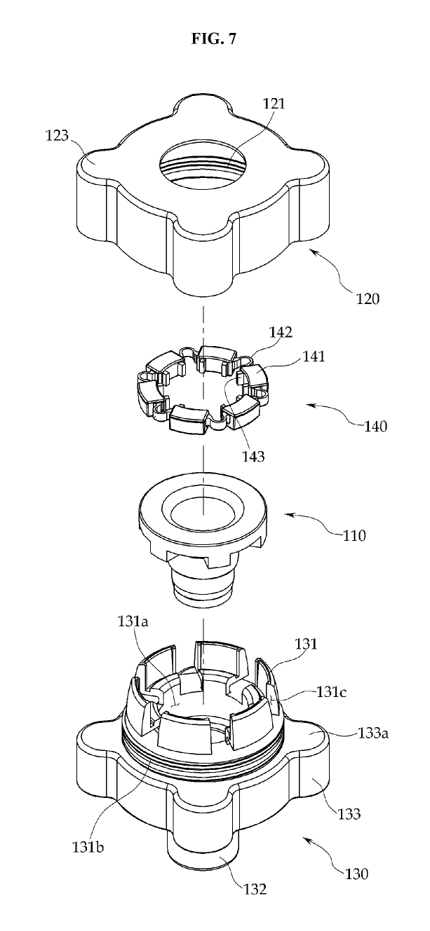

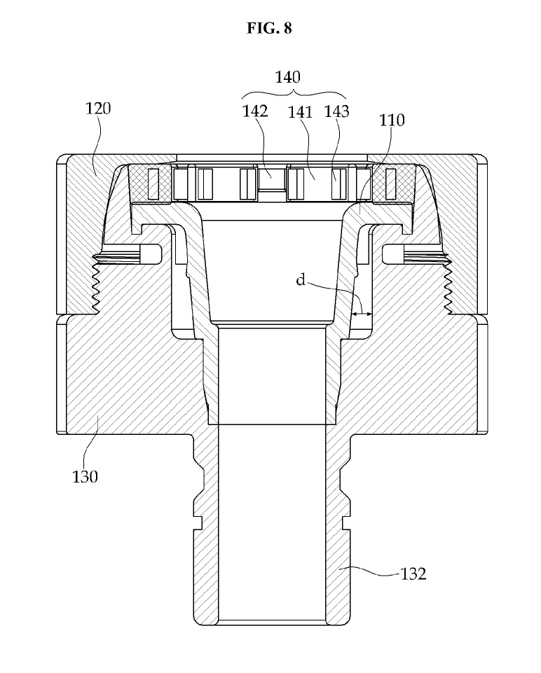

FIGS. 7 and 8 are an exploded perspective view and a cross-sectional view of an exemplary device for connecting a tap and/or external water source and a water supply hose according to embodiments of the present invention.

An exemplary connection device 100 according to embodiments of the present invention include an elastic sealing unit 110, a fixation unit (e.g., a seal or gasket) 140, a tightening unit 120, and a connection unit 130.

The elastic sealing unit 110, the tightening unit 120, and the connection unit 130 may be substantially as described above.

The fixation unit 140 comprises a portion on top of the elastic sealing unit 110 between the top of the elastic sealing unit 110 and the tightening unit 120. The fixation unit 140 contacts an outer surface of an end of the tap, and compresses and helps seal to the elastic sealing unit 110 when the tightening unit 120 and the connection unit 130 are coupled with each other.

The fixation unit 140 includes a plurality of fixation portions 141 at intervals along a circumference thereof, connection portions 142 configured to flexibly connect the fixation portions 141 to each other, and metal pins or projections 143 on the fixation portions and contact the outer surface of the tap.

In the fixation unit 140, the metal pins 143 may be placed in a mold, and thereafter, the fixation portions 141 and the connection portions 142 are integrally formed by molding (e.g., insert injection molding). The connection portions 142 provide an elastic force (e.g., similar to an elastic band).

The fixation unit 140 is pressed by the connection unit 130 when tightening the tightening unit 120, and as a result, the metal pins 143 move inwardly and press onto the outer surface of the tap as intervals or spacings between the fixation portions 141 decrease. Further, when the tightening unit 120 is released, the metal pins 143 move outwardly to easily remove the connection device from the tap and/or external water source as the intervals and/or spacing between the fixation portions 141 increase.

The exemplary embodiments disclosed in the present specification have been described with reference to the accompanying drawings. As described above, the exemplary embodiments illustrated in the respective drawings shall not be limiting, and the exemplary embodiments may be combined by those fully understanding the contents of the present specification. When the exemplary embodiments are combined, some constituent elements may be omitted.

Therefore, it should be understood that the exemplary embodiments described above are not limiting, but only an example in all respects. The scope of the present disclosure is expressed by claims below, not the detailed description, and all changes and modifications achieved from the meanings and scope of claims and equivalent concepts are included in the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A device for connecting a tap and/or external water source and a hose, comprising:
an elastic sealing unit configured to receive or contact an end of the tap and/or external water source;
a tightening unit including a screw groove on an inner surface thereof, and having an inner diameter that decreases from an opening to a bottom of the screw groove; and
a connection unit including a coupling portion having the elastic sealing unit therein, a screw thread on an outer peripheral surface thereof configured to mate with or receive the screw groove of the tightening unit, and a hose connection portion configured to connect an end of the hose,
wherein an inner diameter of the elastic sealing unit is smaller than an outer diameter of the end of the tap and/or external water source, and an inner diameter of the elastic sealing unit decreases from one end to another end.

2. The device of claim 1, wherein the inner diameter of the elastic sealing unit has a tapered, widening, truncated cone or conical shape.

3. The device of claim 2, wherein the inner diameter gradually decreases from one end to a middle section of the elastic sealing unit.

4. The device of claim 1, further comprising a fixation unit on one end of the elastic sealing unit and fixed on an outer surface of the end of the tap and/or external water source.

5. The device of claim 4, wherein:
the fixation unit comprises a plurality of fixation portions at intervals in a circumference of the function, connection portions connecting the fixation portions to each other, and
metal pins on the fixation portions and contacting the outer surface (of the end of) the tap and/or external water source.

6. The device of claim 1, wherein the outer diameter of the elastic sealing unit decreases from one end to the other end.

7. The device of claim 1, wherein the elastic sealing unit comprises a flange portion that contacts a top section of the connection unit.

8. The device of claim 7, wherein the flange portion contacts an upper and/or distal end of the connection unit.

9. The device of claim 1, further comprising a plurality of cutout grooves in the coupling portion of the connection unit.

10. The device of claim 1, wherein the connection unit comprises one or more projections that extend outwards between the coupling portion and the hose connection portion.

11. The device of claim 1, wherein the connection unit comprises an elastic material.

12. The device of claim 11, wherein the elastic material comprises a natural rubber or a synthetic rubber.

13. The device of claim 1, further comprising a suspension groove or a suspension protrusion on the outer peripheral surface of the hose connection portion.

14. The device of claim 1, wherein the elastic sealing unit comprises an elastic material.

15. The device of claim 14, wherein the elastic material comprises a natural rubber or a synthetic rubber.

16. The device of claim 4, wherein the fixation unit attaches to an outer surface of an end of the tap and/or external water source, and compresses and seals to the elastic sealing unit when the tightening unit and the connection unit are coupled with each other.

17. The device of claim 16, wherein the fixation unit comprises a plurality of fixation portions integral with the connection portions wherein the fixation portions are at intervals along a circumference.

18. The device of claim 17, wherein the fixation unit is sealed by the connection unit by tightening the tightening unit, and the metal pins move inwardly and press onto the outer surface of the tap.

19. A method of connecting a connection device to a tap and/or external water source, comprising:
placing an elastic sealing unit in a coupling portion of a connection unit;
fitting or placing a tightening unit onto an end of the tap and/or external water source;
inserting the end of the tap and/or external water source into the elastic sealing unit; and
assembling the elastic sealing unit with the connection unit.

20. The method of claim 19, wherein assembling the elastic sealing unit with the connection unit comprises rotating the tightening unit while contacting the tightening unit with a coupling portion of the connection unit.
